(19) United States
(12) Patent Application Publication
(10) Pub. No.: US 2013/0044325 A1
(43) Pub. Date: Feb. 21, 2013

(54) TURBIDITY DETECTING DEVICE

(71) Applicant: Tomohiro Koyanagi, Osaka-shi (JP)

(72) Inventor: Tomohiro Koyanagi, Osaka-shi (JP)

(21) Appl. No.: 13/635,174

(22) PCT Filed: Apr. 19, 2011
(86) PCT No.: PCT/JP2011/059595

§ 371 Date: Sep. 14, 2012

(30) Foreign Application Priority Data
May 6, 2010 (JP) 2010-106453

(51) Int. Cl. G01N 21/59

(52) U.S. Cl. 356/442

(57) ABSTRACT

Provided is a turbidity detecting device capable of detecting a small turbidity and a minute change in a turbidity. The turbidity sensor includes: a container; a light emitting part for emitting light from an outside of the container, causing the light to pass through a first wall, and applying the light to a second wall; and a scattered light receiving part for receiving the light emitted by the light emitting part and passing through the second wall. Among an incident angle A at which the light emitted by the light emitting part enters the first wall; an angle D formed between inner wall surfaces of the first wall and the second wall; a refractive index n of a liquid with respect to the light emitted by the light emitting part; a refractive index m of a material of which the first wall and the second wall are foamed; an angle x formed between an outer wall surface and the inner wall surface of the first wall; and an angle y formed between an outer wall surface and the inner wall surface of the second wall, a relationship of the following (Formula 1) holds.

$$m sin ( \begin{matrix}y + \\ arcsin [ \frac{n}{m} sin \{ D - arcsin 〈 \frac{m}{n} sin ( \begin{matrix}x + \\ arcsin \{ \frac{sin A}{m} \}\end{matrix} ) 〉 \} ]\end{matrix} ) > 1 \qquad [ Formula 1 ]$$

### TECHNICAL FIELD

The present invention relates to a turbidity detecting device.

### BACKGROUND ART

Conventionally, there has been a turbidity detecting device (turbidimeter) which irradiates a turbidity-detection-targeted liquid with light and detects a turbidity from an intensity of transmitted light or scattered light. In order to measure a minute change in the turbidity from a change in the intensity of the scattered light, it is required to measure the change in the intensity of the scattered light in a region whose scatter angle is small.

FIG. 11 is a cross-sectional view of a container for containing a turbidity-detection-targeted liquid, to which one example of a principle of the conventional turbidity detecting device will be described with reference. In FIG. 11, a state in which a container 911 of a turbidity detecting device is viewed from an upper direction is shown.

As shown in FIG. 11, in the conventional turbidity detecting device 901, a turbidity-detection-targeted liquid is contained in the container 911. In the turbidity-detection-targeted liquid, a turbid substance 931 is included. When light is applied in a direction indicated by an arrow P, the applied light is scattered by the turbid substance 931 at a scatter angle θ and travels in a direction indicated by an arrow R. The scattered light traveling in the direction indicated by the arrow R is detected by a light receiving part 921. Based on an intensity of the scattered light detected by the light receiving part 921, a turbidity of the liquid contained in the container 911 is detected.

When the scatter angle is small, that is, when an angle θ formed between an optical axis of incident light indicated by the arrow P and an optical axis of the scattered light indicated by the arrow R is small, the light receiving part 921 for receiving the scattered light may receive not only the scattered light but also strong incident light. If the light receiving part 921 also receives the strong incident light, an intensity of weak scattered light cannot be accurately detected, thereby making it impossible to accurately detect the turbidity. In particular, it is made difficult to measure a turbidity of a turbidity-detection-targeted liquid having a small turbidity and a minute change in a turbidity.

On the other hand, Japanese Patent Application Laid-Open Publication No. 2007-113987 (Patent Literature 1) and Japanese Unexamined Patent Application Publication (Translation of PCT Application) No. 2003-515124 (Patent Literature 2) each disclose a turbidimeter which detects scattered light which is scattered in a direction perpendicular to an optical axis of incident light.

FIG. 12 is a cross-sectional view of a container for containing a turbidity-detection-targeted liquid, to which another example of a principle of the conventional turbidity detecting device in which scattered light scattered in a direction perpendicular to an optical axis of incident light is detected will be described with reference. In FIG. 12, a state in which a container 912 of a turbidity detecting device is viewed from an upper direction is shown.

As shown in FIG. 12, in the conventional turbidity detecting device 902, as in the turbidity detecting device 901 (FIG. 11), a turbidity-detection-targeted liquid is contained in the container 912, and a turbid substance 932 is included in the turbidity-detection-targeted liquid. An inside of the container 912 is irradiated with light in a direction indicated by an arrow P. In the turbidity detecting device 902, a light receiving part 922 is located so as to detect light scattered in the direction perpendicular to the optical axis of the incident light. When the light is applied in the direction indicated by the arrow P, the applied light is scattered by the turbid substance 932 at a scatter angle θ and travels in a direction indicated by an arrow R₁. However, when the angle θ is small, the scattered light traveling in the direction indicated by the arrow R₁ is not detected by the light receiving part 922.

When the scattered light traveling in the direction indicated by the arrow R₁ is scattered again by the turbid substance in the turbidity-detection-targeted liquid at a scatter angle θ, the scattered light travels in a direction indicated by an arrow R₂. An angle formed between the incident light indicated by the arrow P and the scattered light indicated by the arrow R₂ is 2θ. Thereafter, when the scattered light indicated by the arrow R₂ is further repeatedly scattered by the turbid substance many times, an angle formed between the incident light indicated by the arrow P and the scattered light gradually increases. When the angle formed between the incident light indicated by the arrow P and the scattered light approaches 90°, the scattered light is detected by the light receiving part 922.

As described above, when the scattered light scattered in the direction perpendicular to the optical axis of the incident light is detected, it is required that many turbid substances are included in the turbidity-detection-targeted liquid and the incident light is scattered many times. Therefore, even by means of the conventional turbidity detecting device 902 shown in FIG. 12, it is difficult to measure the turbidity of the turbidity-detection-targeted liquid having the small turbidity and the minute change in the turbidity.

In addition, even by means of the turbidity detecting device through detecting the turbidity by measuring the change of the transmitted light, since the scattered light having the small scatter angle is received by the light receiving part for receiving the transmitted light, it is difficult to measure the turbidity of the turbidity-detection-targeted liquid having the small turbidity and the minute change in the turbidity.

Then, for the purpose of improving a signal to noise ratio by reducing noise caused by incident light in the detection of scattered light having a small scatter angle, Japanese Patent Application Laid-Open Publication No. 2008-249363 (Patent Literature 3) discloses a turbidimeter utilizing total reflection.

FIG. 13 is a cross-sectional view of a container for containing a turbidity-detection-targeted liquid, to which one example of a principle of the conventional turbidity detecting device utilizing the total reflection will be described with reference. In FIG. 13, a state in which a container 913 of a turbidity detecting device is viewed from a horizontal direction is shown.

As shown in FIG. 13, in the conventional turbidity detecting device 903, as in the turbidity detecting device 901 (FIG. 11), a turbidity-detection-targeted liquid is contained in the container 913, and a turbid substance 933 is included in the turbidity-detection-targeted liquid. Inside the container 913, air is retained in a space between the turbidity-detection-targeted liquid and an inner surface of an upper wall of the container 913. The turbidity-detection-targeted liquid in the container 913 is irradiated with light in a direction indicated by an arrow P from a direction lower than a liquid surface of the turbidity-detection-targeted liquid toward an obliquely upper direction. When incident light emitted in the direction indicated by the arrow P is not scattered by the turbid substance 933, the incident light is totally reflected off the liquid surface of the turbidity-detection-targeted liquid and travels in a direction indicated by an arrow Q. The light totally reflected off the liquid surface of the turbidity-detection-targeted liquid does not travel in a direction higher than the liquid surface.

On the other hand, when the incident light applied in the direction indicated by the arrow P is scattered by the turbid substance 933, the scattered light is scattered at a scatter angle θ formed from an optical axis of the arrow P. Depending on a magnitude of the angle θ, the scattered light is not totally reflected off the liquid surface and travels in the direction higher than the liquid surface. The scattered light traveling in the direction higher than the liquid surface is detected by a light receiving part 923.

The incident light is caused to be totally reflected off the liquid surface of the turbidity-detection-targeted liquid and the incident light is thereby caused not to be applied to the light receiving part 923, thus allowing the light receiving part 923 to receive only the scattered light. In this way, the noise caused by the incident light is reduced, thereby allowing the signal to noise ratio to be improved.

### CITATION LIST

### Patent Literature

Patent Literature 1: Japanese Patent Application Laid-Open Publication No. 2007-113987
Patent Literature 2: Japanese Unexamined Patent Application Publication (Translation of PCT Application) No. 2003-515124
Patent Literature 3: Japanese Patent Application Laid-Open Publication No. 2008-249363

### SUMMARY OF THE INVENTION

### Technical Problem

However, in the turbidimeter disclosed in Japanese Patent Application Laid-Open Publication No. 2008-249363 (Patent Literature 3) or the turbidity detecting device 903 shown in FIG. 13, when the liquid surface of the turbidity-detection-targeted liquid sways, it may occur that the incident light is not totally reflected off the liquid surface of the turbidity-detection-targeted liquid. When the incident light is not totally reflected off the liquid surface of the turbidity-detection-targeted liquid, the incident light may be received by the light receiving part 923. The incident light is received by the light receiving part 923, thereby making it impossible to accurately detect weak scattered light.

In addition, when the liquid surface of the turbidity-detection-targeted liquid sways, even if the incident light is totally reflected off the liquid surface of the turbidity-detection-targeted liquid, directions, in each of which the scattered light emitted into the air from the turbidity-detection-targeted liquid travels, vary, thereby making it impossible to accurately detect the turbidity.

Therefore, an object of the present invention is to provide a turbidity detecting device capable of detecting a turbidity of a turbidity-detection-targeted liquid having a small turbidity and a minute change in a turbidity.

### Solution to Problem

A turbidity detecting device according to the present invention includes: a container, a light emitting part, and a light receiving part. The container includes a first wall and a second wall and contains a liquid. The light emitting part emits light from an outside of the container, causes the light to pass through the first wall, and applies the light to the second wall. The light receiving part receives the light emitted by the light emitting part and passing through the second wall.

In the turbidity detecting device according to the present invention, among an incident angle A at which the light emitted by the light emitting part enters the first wall of the container from the outside of the container; an angle D (0°≦D<180°) formed between an inner wall surface of the first wall and an inner wall surface of the second wall; a refractive index n of the liquid contained in the container with respect to the light emitted by the light emitting part; a refractive index m of a material of which the first wall and the second wall are formed, with respect to the light emitted by the light emitting part; an angle x (−90°≦x≦90°) formed between an outer wall surface and the inner wall surface of the first wall; and an angle y (−90°≦y≦90°) formed between an outer wall surface and the inner wall surface of the second wall, a relationship of the following (Formula 1) holds.

$$m sin ( \begin{matrix}y + \\ arcsin [ \frac{n}{m} sin \{ D - arcsin 〈 \frac{m}{n} sin ( \begin{matrix}x + \\ arcsin \{ \frac{sin A}{m} \}\end{matrix} ) 〉 \} ]\end{matrix} ) > 1 \qquad [ Formula 1 ]$$

FIG. 1 is a partial cross-sectional view of a container for containing a liquid, to which a principle of the turbidity detecting device according to the present invention will be described with reference. In FIG. 1, a state in which the container is viewed from an upper direction is shown.

As shown in FIG. 1, the turbidity detecting device 101 includes: the container including the first wall 11 and the second wall 12; the light emitting part 21; and the light receiving part 22. The first wall 11 and the second wall 12 shown in FIG. 1 are parts of the container wall, and the container are composed of the first wall 11, the second wall 12, and another wall. The other wall of the container is not shown. In a region W enclosed with the first wall 11 and the second wall 12, the liquid is contained. The angle formed between the inner wall surface of the first wall 11 and the inner wall surface of the second wall 12 is the angle D (0°≦D<180°). In a case where the inner wall surface of the first wall 11 and the inner wall surface of the second wall 12 are located in parallel with each other, the angle D is defined as being equal to 0°. In FIG. 1, an inside of the container is defined as the region W and an outside of the container is defined as a region Z. The region W is supposed to be filled with the liquid and the region Z is supposed to be filled with air.

The angle formed between the outer wall surface and the inner wall surface of the first wall 11 is the angle x (−90°≦x≦90°). The angle formed between the outer wall surface and the inner wall surface of the second wall 12 is the angle y (−90°≦y≦90°). The angle x and the angle y are determined as follows. As shown in FIG. 1, a point at which a line extending in a direction along the outer wall surface of the first wall 11 intersects a line extending in a direction along the inner wall surface of the first wall 11 is defined as an intersection point K. The angle x formed between the outer wall surface and the inner wall surface of the first wall 11 is determined as an angle having a positive magnitude in a counterclockwise direction from the inner wall surface toward the outer wall surface of the first wall 11 with the intersection point K being the center or a negative magnitude in a clockwise direction with the intersection point K being the center. In a case where the inner wall surface and the outer wall surface of the first wall 11 are located in parallel with each other, the angle x is defined as being equal to 0°. The angle y is also determined in the same manner as mentioned above with respect to the second wall 12. In FIG. 1, as one example, a state in which the angle x is an angle having a negative magnitude and the angle y is an angle having a positive magnitude is shown.

As shown in FIG. 1A, when the light emitting part 21 emits the light from the outside of the container in a direction indicated by an arrow P, the light is applied to the inside of the first wall 11 at the incident angle A. The light having passed through the first wall 11 passes through the region W and is applied to the second wall 12.

In a case where when no turbid substance is included in the liquid contained in the container, among the incident angle A, the angle D formed between the inner wall surface of the first wall 11 and the inner wall surface of the second wall 12, the refractive index n of the liquid contained in the container with respect to the light emitted by the light emitting part 21, the refractive index m of the material of which the first wall 11 and the second wall 12 are formed with respect to the light emitted by the light emitting part 21, the angle x formed between the outer wall surface and the inner wall surface of the first wall 11, and the angle y formed between the outer wall surface and the inner wall surface of the second wall 12, the relationship of (Formula 1) holds, the light applied to the second wall 12 is substantially totally reflected off the second wall 12. The totally reflected light travels in a direction indicated by an arrow Q, passes through the second wall 12, and is not emitted to an outside of the second wall 12. Accordingly, the light emitted by the light emitting part 21 is not received by the light receiving part 22.

In a case where the angle x formed between the outer wall surface and the inner wall surface of the first wall 11 and the angle y formed between the outer wall surface and the inner wall surface of the second wall 12 are both 0°, that is, in a case where the outer wall surface and the inner wall surface of the first wall 11 are in parallel with each other and the outer wall surface and the inner wall surface of the second wall 12 are in parallel with each other, among the incident angle A, the angle D formed between the inner wall surface of the first wall 11 and the inner wall surface of the second wall 12, and the refractive index n of the liquid contained in the container with respect to the light emitted by the light emitting part 21, a relationship of (Formula 1)=n sin [D−arcsin {(sin A)/n}]>1 holds.

On the other hands, as shown in FIG. 1B, when a turbid substance 30 is included in the liquid contained in the container, the light emitted by the light emitting part 21 is scattered by the turbid substance 30. The scattered light is scattered in a direction indicated by an arrow R at a scatter angle θ from an optical axis of the light applied to the turbid substance 30.

Depending on a magnitude of the angle θ, the scattered light scattered by the turbid substance 30 is not totally reflected off the second wall 12 and passes through the second wall 12. The scattered light passing through the second wall 12 is received by the light receiving part 22. Since the light not scattered by the turbid substance 30, of the light emitted by the light emitting part 21, is substantially totally reflected off the second wall 12 and travels in a direction indicated by an arrow Q, the light is not received by the light receiving part 22. In this way, even when the angle θ of the scatter angle is small and the intensity of the scattered light is weak, the light receiving part 22 can detect the scattered light in a highly sensitive manner.

In this way, the turbidity detecting device capable of detecting a turbidity of a turbidity-detection-targeted liquid having a small turbidity and a minute change in a turbidity can be provided.

In addition, in the turbidity detecting device according to the present invention, it is preferable that the first wall and the second wall are formed of a material whose refractive index m with respect to the light emitted by the light emitting part is greater than or equal to √2; the angle D formed between the inner wall surface of the first wall and the inner wall surface of the second wall is 90°; each of the angle x formed between the outer wall surface and the inner wall surface of the first wall and the angle y formed between the outer wall surface and the inner wall surface of the second wall is 0°; and the magnitude of the refractive index m with respect to the light emitted by the light emitting part is greater than or equal to the magnitude of the refractive index n of the liquid contained in the container.

Note that √2 indicates a square root.

FIG. 2 is a partial cross-sectional view of the container for containing the liquid, to which the principle of the turbidity detecting device according to the present invention will be described with reference. In FIG. 2, a state in which the container is viewed from an upper direction.

As shown in FIG. 2, the turbidity detecting device 102 includes: the container including the first wall 11 and the second wall 12; the light emitting part 21; and the light receiving part 22. The first wall 11 and the second wall 12 shown in FIG. 2 are parts of a container wall, and the container are composed of the first wall 11, the second wall 12, and another wall. The other wall of the container is not shown. In a region W enclosed with the first wall 11 and the second wall 12, a liquid is contained. An angle D formed between the first wall 11 and the second wall 12 of the turbidity detecting device 102 is 90°. An outer wall surface and an inner wall surface of the first wall 11 are formed so as to be in parallel with each other. In other words, an angle x is 0°. In addition, an outer wall surface and an inner wall surface of the second wall 12 is formed so as to be in parallel with each other. In other words, an angle y is 0°. A refractive index m of each of the first wall 11 and the second wall 12 with respect to light emitted by the light emitting part 21 is, for example, √2. In the region W between the first wall 11 and the second wall 12, the liquid is contained. In FIG. 2, an inside of the container is defined as the region W and an outside of the container is defined as a region Z. The region W is supposed to be filled with the liquid and the region Z is supposed to be filled with air. A refractive index n of the liquid contained in the container with respect to the light emitted by the light emitting part 21 is √2. A refractive index of the air with respect to the light emitted by the light emitting part 21 is substantially one.

When light emitting part 21 emits the light in a direction indicated by an arrow P from an outside of the container, the emitted light is applied to an inside of the first wall 11 at an incident angle A. The light having passed through the first wall 11 passes through the region W and is applied to the second wall 12.

A magnitude of the incident angle A is a magnitude ranging from 0° to 90°. In addition, because the refractive index m of the first wall 11 with respect to the light emitted by the light emitting part 21 and the refractive index n of the liquid contained in the container with respect to the light emitted by the light emitting part 21 are both √2, a magnitude of an refracting angle B, shown in FIG. 2, resulting when the light emitted by the light emitting part 21 is applied from the first wall 11 to the liquid is smaller than 45°.

Because the angle D formed between the inner wall surface of the first wall 11 and the inner wall surface of the second wall 12 is 90°, a magnitude of an incident angle C resulting when the light emitted by the light emitting part 21 is applied from the second wall 12 into the air is larger than 45°. At this time, a magnitude of a refracting angle E resulting when the light emitted by the light emitting part 21 is applied from the second wall 12 into the air is larger than 90°. In other words, when entering the air from the second wall 12, the light emitted by the light emitting part 21 is totally reflected.

As described above, the first wall and the second wall of the turbidity detecting device are formed of the material whose refractive index m with respect to the light emitted by the light emitting part is greater than or equal to √2, the angle D formed between the inner wall surface of the first wall and the inner wall surface of the second wall is 90°, and the refractive index n of the liquid contained in the container with respect to the light emitted by the light emitting part is greater than or equal to √2, thereby allowing the light emitted by the light emitting part and not scattered by the turbid substance to be substantially totally reflected off the second wall.

In the turbidity detecting device according to the present invention, it is preferable that the container includes a third wall. It is preferable that the third wall is located such that light passing through the first wall is reflected off an inner wall surface of the third wall and thereafter, is applied to the second wall.

In this way, a probability at which the light emitted by the light emitting part is applied to the turbid substances is enhanced, thereby allowing an intensity of the scattered light to be heightened.

In the turbidity detecting device according to the present invention, it is preferable that in the container, an inlet port causing the liquid to flow into the container and an outlet port causing the liquid flow out from the container are formed.

By employing this configuration, while the liquid is being flowing into the container, a turbidity of the liquid can be detected.

In the turbidity detecting device according to the present invention, it is preferable that the light emitted by the light emitting part is blue-color light.

In this way, an intensity of the scattered light can be heightened.

In the turbidity detecting device according to the present invention, it is preferable that the light emitted by the light emitting part is laser light.

In this way, an intensity of the scattered light can be heightened. In addition, a turbidity can be more accurately detected.

It is preferable that the turbidity detecting device according to the present invention includes a totally reflected light receiving part which receives the light being emitted by the light emitting part and being totally reflected off the second wall.

As described above, by receiving not only the scattered light but also the light totally reflected off the second wall, even in a case where the first wall 111 or the second wall of the container is dirty or the liquid is colored, based on the intensity of the totally reflected light, the intensity of the scattered light can be corrected.

In the turbidity detecting device according to the present invention, it is preferable that the light emitting part emits light having a first wavelength and light having a second wavelength.

In a case where the first wall or the second wall is dirty or the liquid is colored, it is required to correct the actually measured intensity of the scattered light to an intensity of the scattered light resulting when a transmittance is 100%.

As a method for the correction, for example, of the light having the first wavelength and the light having the second wavelength, the light having the relatively short wavelength is used to measure the intensity of the scattered light and the light having the relatively long wavelength is used to measure an intensity of transmitted light. First, before the liquid is contained in the container, an intensity of the transmitted light in a position at a distance L from the light emitting part is previously measured, and the measured intensity is defined as an initial transmitted light intensity. Next, after the liquid has been contained in the container, an intensity of the scattered light in the position at the distance L from the light emitting part and an intensity of the transmitted light in a position at the distance L from the light emitting part are measured, and by using {the scattered light intensity/(the transmitted light intensity/the initial transmitted light intensity)}=a post-correction scattered light intensity, the post-correction scattered light intensity can be calculated.

In this way, even in the case where the first wall or the second wall of the container is dirty or the liquid is colored, based on the intensity of the transmitted light, the intensity of the scattered light can be corrected.

### Advantageous Effects of the Invention

As described above, according to the present invention, a turbidity detecting device capable of detecting a minute change in a turbidity can be provided.

### BRIEF DESCRIPTION OF THE DRAWINGS

FIG. 1A and FIG. 1B are partial cross-sectional views of a container for containing a liquid, to which a principle of a turbidity detecting device according to the present invention will be described with reference.

FIG. 2 is a partial cross-sectional view of the container for containing the liquid, to which the principle of the turbidity detecting device according to the present invention will be described with reference.

FIG. 3 is a diagram schematically illustrating a cross section of a container for containing a liquid, to which a principle of a turbidity sensor according to a first embodiment of the present invention will be described with reference.

FIG. 4 is a perspective view schematically illustrating the whole of the container for containing the liquid, to which the principle of the turbidity sensor according to the first embodiment of the present invention will be described with reference.

FIG. 5 is a diagram schematically illustrating a cross section of a container for containing a liquid, to which a principle of a turbidity sensor according to a second embodiment of the present invention will be described with reference.

FIG. 6 is a diagram schematically illustrating a cross section of a container for containing a liquid, to which a principle of a turbidity sensor according to a third embodiment of the present invention will be described with reference.

FIG. 7A and FIG. 7B are diagrams schematically illustrating a cross section of a container for containing a liquid, to which a principle of a turbidity sensor according to a fourth embodiment of the present invention will be described with reference.

FIG. 8A and FIG. 8B are diagrams schematically illustrating a cross section of a container for containing a liquid, to which a principle of a turbidity sensor according to a fifth embodiment of the present invention will be described with reference.

FIG. 9 is a perspective view schematically illustrating the whole of a turbidity sensor according to a sixth embodiment of the present invention.

FIG. 10 is a perspective view schematically illustrating the whole of a turbidity sensor according to a seventh embodiment of the present invention.

FIG. 11 is a diagram illustrating a cross section of a container for containing a turbidity-detection-targeted liquid, to which one example of a principle of the conventional turbidity detecting device will be described with reference.

FIG. 12 is a diagram illustrating a cross section of a container for containing a turbidity-detection-targeted liquid, to which a principle of another example of the conventional turbidity detecting device which detects scattered light in a direction perpendicular to an optical axis of incident light will be described with reference.

FIG. 13 is a diagram illustrating a cross section of a container for containing a turbidity-detection-targeted liquid, to which a principle of the conventional turbidity detecting device utilizing total reflection will be described with reference.

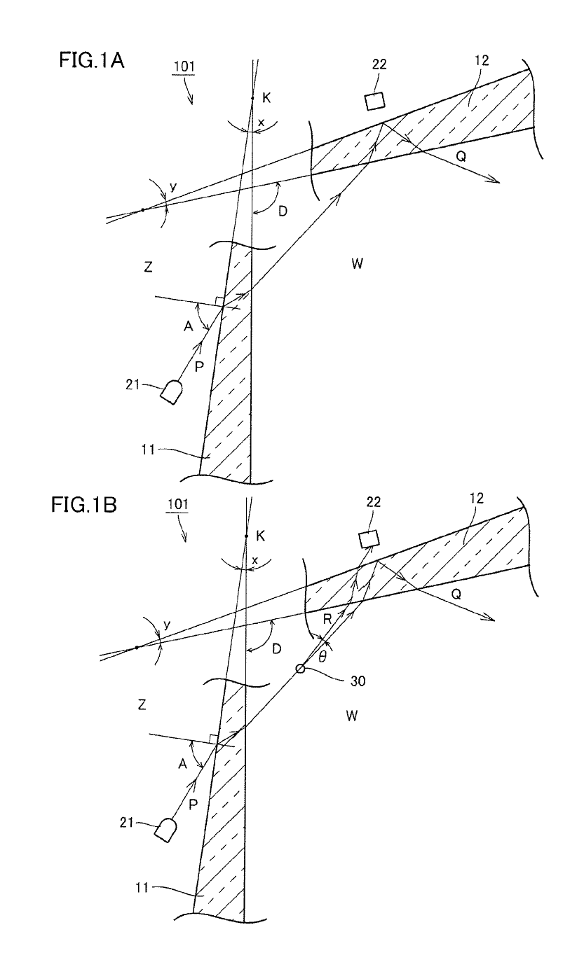

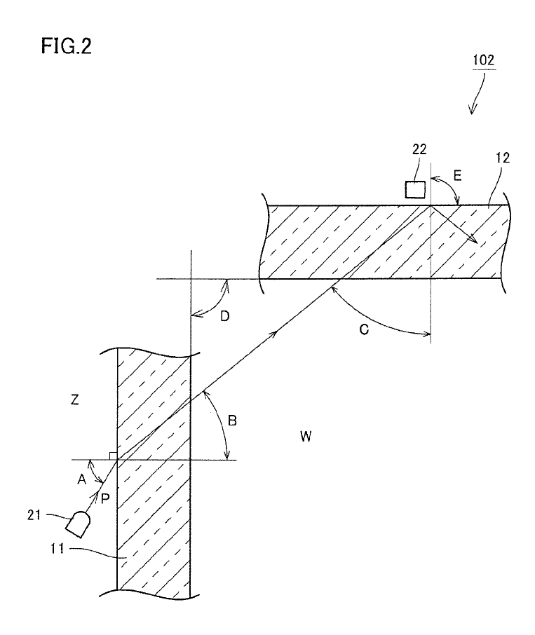

### DESCRIPTION OF EMBODIMENTS

Hereinafter, embodiments of the present invention will be described with reference to the accompanying drawings.

### First Embodiment

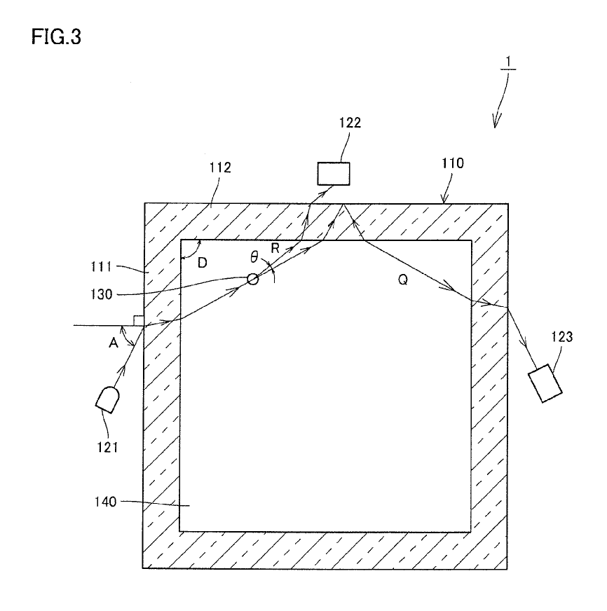

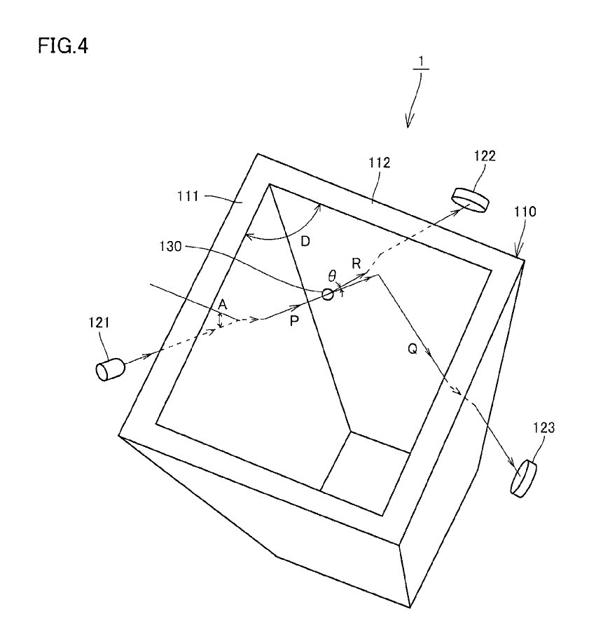

In FIG. 3, a state in which a container 110 of a turbidity sensor 1 as a turbidity detecting device according to a first embodiment of the present invention is viewed from an upper direction is shown. In FIG. 4, a state in which the container 110 of the turbidity sensor 1 is viewed from an obliquely upper direction is shown. As shown in FIG. 3 and FIG. 4, the turbidity sensor 1 includes: the container 110; a light emitting part 121; a scattered light receiving part 122 as a light receiving part; and a transmitted light receiving part 123 as a totally reflected light receiving part. The container 110 includes a first wall 111 and a second wall 112. In the present embodiment, the container 110 is formed so as to be of a rectangular parallelepiped shape. In the container 110, a liquid 140 is contained. In the liquid 140, a turbid substance 130 is included.

In the present embodiment, each of the first wall 111 and the second wall 112 is formed so as to be of, for example, a flat plate shape. An outer wall surface and an inner wall surface of the first wall 111 are substantially in parallel with each other, and an outer wall surface and an inner wall surface of the second wall 112 are substantially in parallel with each other. The inner wall surface of the first wall 111 and the inner wall surface of the second wall 112 are located so as to form an angle D (0°≦D<180°). A wall of the container 110, including the first wall 111 and the second wall 112, is formed of a transparent material, that is, a material capable of causing visible light to pass therethrough. As the material of which the first wall 111 and the second wall 112 are formed, for example, an acrylic resin, polycarbonate, vinyl chloride, glass, quartz, a polyethylene resin, an olefin-based resin, or the like is used.

The light emitting part 121 emits light toward the first wall 111 in a direction indicated by an arrow P. The light emitted by the light emitting part 121 is light in a visible light region. As the light emitted by the light emitting part 121, light having a short wavelength is preferable, and for example, blue-color light is preferable. In addition, it is preferable that the light emitted by the light emitting part 121 is laser light. The light emitting part 121 is located outside the first wall 111 such that the light emitted by the light emitting part 121 enters the first wall 111 at an incident angle A.

The scattered light receiving part 122 is located outside the second wall 112. The transmitted light receiving part 123 is located outside a wall facing the first wall 111. The scattered light receiving part 122 and the transmitted light receiving part 123 receive the light and transmit signals to a computing part (not shown). The computing part which have received the signals from the scattered light receiving part 122 and the transmitted light receiving part 123 detect a turbidity of the liquid 140 contained in the container 110 based on intensities of the light received by the scattered light receiving part 122 and the transmitted light receiving part 123.

A refractive index of each of the first wall 111 and the second wall 112 with respect to the light emitted by the light emitting part 121 is defined as m. In addition, a refractive index of the liquid 140 with respect to the light emitted by the light emitting part 121 is defined as n.

Among an incident angle A at which the light emitted by the light emitting part 121 enters the first wall 111 from an outside of the container 110, an angle D formed between the inner wall surface of the first wall 111 and the inner wall surface of the second wall 112, and the refractive index n of the liquid 140 contained in the container 110 with respect to the light emitted by the light emitting part 121, a relationship of the following (Formula 1) holds.

$$m sin ( \begin{matrix}y + \\ arcsin [ \frac{n}{m} sin \{ D - arcsin 〈 \frac{m}{n} sin ( \begin{matrix}x + \\ arcsin \{ \frac{sin A}{m} \}\end{matrix} ) 〉 \} ]\end{matrix} ) > 1 \qquad [ Formula 1 ]$$

In the turbidity sensor 1 configured as described above, the light emitted by the light emitting part 121 enters the first wall 111 at the incident angle A. The light incident upon the first wall 111 is refracted inside the first wall 111 and is also refracted when entering the liquid 140 from the first wall 111. When the light incident in the liquid 140 in such a manner is not applied to the turbid substance 130 in the liquid 140, the light directly travels in a straight manner and is applied to the second wall 112.

When among the incident angle A at which the light emitted by the light emitting part 121 enters the first wall 111 from the outside of the container 110, the angle D formed between the inner wall surface of the first wall 111 and the inner wall surface of the second wall 112, and the refractive index n of the liquid 140 contained in the container 110 with respect to the light emitted by the light emitting part 121, the relationship of the (Formula 1) holds, the light emitted by the light emitting part 121 and not scattered by the turbid substance 130 is substantially totally reflected off the inner wall surface or the outer wall surface of the second wall 112. The totally reflected light travels in a direction indicated by an arrow Q.

The light totally reflected off the second wall 112 and traveling in the direction indicated by the arrow Q passes through the wall facing the first wall 111 and is received by the transmitted light receiving part 123.

As described above, the transmitted light receiving part 123 receives the light not scattered by the turbid substance 130 in the liquid 140.

On the other hand, there may be a case where the light emitted by the light emitting part 121 is applied to the turbid substance 130 in the liquid 140. The light applied to the turbid substance 130 by the light emitting part 121 is scattered by the turbid substance 130 at a scatter angle θ. The scattered light scattered at the scatter angle θ travels in a direction indicated by an arrow R. Depending on a magnitude of the scatter angle θ, the scattered light traveling in the direction indicated by the arrow R is not totally reflected off the second wall 112 and passes through the second wall 112. The scattered light having passed through the second wall 112 is received by the scattered light receiving part 122.

As described above, the scattered light receiving part 122 receives the light scattered by the turbid substance 130 in the liquid 140.

As described above, since the light not scattered by the turbid substance 130 is totally reflected off the second wall 112, the light not scattered by the turbid substance 130 is not received by the scattered light receiving part 122. In such a manner, the scattered light receiving part 122 can receive only the light scattered by the turbid substance 130.

In addition, it is preferable that the light emitting part 121 emits light having a plurality of wavelengths. For example, as first-wavelength-light, blue-color light is emitted, and as second-wavelength-light, red-color light is emitted. In this way, even in a case where the first wall 111 or the second wall 112 of the container 110 is dirty or the liquid 140 is colored, based on an intensity of the transmitted light received by the transmitted light receiving part 123, an intensity of the scattered light received by the scattered light receiving part 122 can be corrected.

As a method for correcting the intensity of the scattered light based on the intensity of the transmitted light by emitting the light having the plurality of wavelengths, for example, there is the below-described method. First, a light source for scattered light having a wavelength of 470 nm and a light source for transmitted light having a wavelength of 660 nm are prepared. A distance between the light source for the scattered light and the scattered light receiving part 122 and a distance between the light source for the transmitted light and the transmitted light receiving part 123 are made the same as each other. Next, an intensity of initial transmitted light, an intensity of current transmitted light, and an intensity of the scattered light are measured. Based on these, by using {scattered light intensity/(transmitted light intensity/initial transmitted light intensity)}=post-correction scattered light intensity, the post-correction scattered light intensity is calculated. Here, a value of (transmitted light intensity/initial transmitted light intensity) is defined as a transmittance after a transmission intensity has been reduced due to the first wall 111 or the second wall 112 being dirty or the liquid being colored. By dividing the scattered light intensity by this value, the intensity of the scattered light can be corrected to a value in a case where the transmittance is 100%.

In this way, in a case where the first wall 111 or the second wall 112 is dirty or the liquid is colored, the intensity of the scattered light can be corrected.

In the present embodiment, for example, the first wall 111 and the second wall 112 of the container 110 are formed of polymethyl methacrylate (PMMA). As the liquid 140 contained in the container 110, water is used. The light emitted by the light emitting part 121 is, for example, sodium D-line light (a wavelength of 589.3 nm). At this time, a refractive index n of the liquid 140 with respect to the light emitted by the light emitting part 121 is 1.33 and a refractive index m of each of the first wall 111 and the second wall 112 with respect to the light emitted by the light emitting part 121 is 1.49. A magnitude of the refractive index m (=1.49) is greater than or equal to a magnitude of the refractive index n (=1.33). The light emitting part 121 is located such that the light emitted by the light emitting part 121 enters the first wall 111 at the incident angle A of, for example, 60°. In addition, the container 110 is formed such that the angle D formed between the inner wall surface of the first wall 111 and the inner wall surface of the second wall 112 comes to be 90°. The container 110 is placed in the air, and a refractive index of the air with respect to the light emitted by the light emitting part 121 is one. In addition, an angle x formed between the outer wall surface and the inner wall surface of the first wall 111 is set to 0°, and an angle y formed between the outer wall surface and the inner wall surface of the second wall 112 is set to 0°.

In the turbidity sensor 1 configured as described above, because in (Formula 1), x is equal to 0° and y is equal to 0°, a relationship of (Formula 1)=n sin [D−arcsin {(sin A)/n}]=1.33 sin [90°−arcsin {(sin 60°)/1.33}]=1.01>1 holds.

When the turbidity sensor 1 is configured as described above, the light applied by the light emitting part 121 to the first wall 111 at the incident angle 60° enters the first wall 111 at a refracting angle 35.5°. The light having entered the first wall 111 passes through the first wall 111 and travels in a straight manner in the liquid 140. The light not scattered by the turbid substance 130 in the liquid 140 enters the second wall 112. The light having entered the second wall 112 enters the air from the second wall 112 at an incident angle 42.6°. Here, because the refractive index m of the second wall 112 with respect to the light emitted by the light emitting part 121 is 1.49, a total reflection angle is 42.16°. Therefore, the light traveling in the second wall 112 does not go out from the second wall 112 into the air and is substantially totally reflected off the outer wall surface of the second wall 112.

As described above, the turbidity sensor 1 according to the first embodiment includes: the container 110; the light emitting part 121; and the scattered light receiving part 122. The container 110 includes the first wall 111 and the second wall 112 and contains the liquid 140. The light emitting part 121 causes the light to pass through the first wall 111 from the outside of the container 110 and applies the light to the second wall 112. The scattered light receiving part 122 receives the light emitted by the light emitting part 121 and passing through the second wall 112.

In the turbidity sensor 1 according to the present invention, among the incident angle A at which the light emitted by the light emitting part 121 enters the first wall 111 of the container 110 from the outside of the container 110; the angle D (0°≦D<180°) formed between the inner wall surface of the first wall 111 and the inner wall surface of the second wall 112; the refractive index n of the liquid 140 contained in the container 110 with respect to the light emitted by the light emitting part 121; the refractive index m of the material, of which the first wall 111 and the second wall 112 are formed, with respect to the light emitted by the light emitting part; the angle x (−90°<x<90°) formed between the outer wall surface and the inner wall surface of the first wall 111; and the angle y (−90°<y<90°) formed between the outer wall surface and the inner wall surface of the second wall 112, a relationship of the following (Formula 1) holds.

$$m sin ( \begin{matrix}y + \\ arcsin [ \frac{n}{m} sin \{ D - arcsin 〈 \frac{m}{n} sin ( \begin{matrix}x + \\ arcsin \{ \frac{sin A}{m} \}\end{matrix} ) 〉 \} ]\end{matrix} ) > 1 \qquad [ Formula 1 ]$$

When the light emitting part 121 emits the light in the direction indicated by the arrow P from the outside of the container 110, the emitted light enters the first wall 111 at the incident angle A. The light having passed through the first wall 111 passes through the liquid 140 and enters the second wall 112.

In a case where the turbid substance 130 is not included in the liquid 140 contained in the container 110, when among the incident angle A; the angle D formed between the inner wall surface of the first wall 111 and the inner wall surface of the second wall 112; the refractive index n of the liquid 140 contained in the container 110 with respect to the light emitted by the light emitting part 121; the refractive index m of the material, of which the first wall 111 and the second wall 112 are formed, with respect to the light emitted by the light emitting part 21; the angle x formed between the outer wall surface and the inner wall surface of the first wall 111; and the angle y formed between the outer wall surface and the inner wall surface of the second wall 112, the relationship of (Formula 1) holds, the light entering the second wall 112 is substantially totally reflected off the second wall 112. The totally reflected light travels in the direction indicated by the arrow Q, does not pass through the second wall 112, and is not emitted to the outside of the second wall 112. Accordingly, the light emitted by the light emitting part 121 is not received by the scattered light receiving part 122.

On the other hand, in a case where the turbid substance 130 is included in the liquid 140 contained in the container 110, the light emitted by the light emitting part 121 is scattered by the turbid substance 130. The scattered light is scattered at a scatter angle θ from an optical axis of the light having entered the turbid substance 130 in the direction indicated by the arrow R.

Depending on a magnitude of the angle θ, the scattered light scattered by the turbid substance 130 is not totally reflected off the second wall 112 and passes through the second wall 112. The scattered light passing through the second wall 112 is received by the scattered light receiving part 122. Since the light not scattered by the turbid substance 130, of the light emitted by the light emitting part 121, is substantially totally reflected off the second wall 112 and travels in the direction indicated by the arrow Q, the light is not received by the scattered light receiving part 122. In this way, even when the angle θ of the scatter angle is small and the intensity of the scattered light is weak, the scattered light receiving part 122 can detect the scattered light in a highly sensitive manner.

In this way, the turbidity sensor 1 capable of detecting the turbidity of the liquid 140 having the small turbidity and the minute change in the turbidity can be provided.

In addition, in the turbidity sensor 1 according to the first embodiment, the first wall 111 and the second wall 112 are formed of a material whose refractive index m with respect to the light emitted by the light emitting part 121 is greater than or equal to√2; the angle D formed between the inner wall surface of the first wall 111 and the inner wall surface of the second wall 112 is 90°; each of the angle x formed between the outer wall surface and the inner wall surface of the first wall 111 and the angle y formed between the outer wall surface and the inner wall surface of the second wall 112 is 0°; and the magnitude of the refractive index m with respect to the light emitted by the light emitting part 121 is greater than or equal to the magnitude of the refractive index n of the liquid 140 contained in the container 110.

By employing the above-described configuration, the light emitted by the light emitting part 121 and not scattered by the turbid substance 130 can be substantially totally reflected off the second wall 112.

In addition, in the turbidity sensor 1 according to the first embodiment, it is preferable that the light emitted by the light emitting part 121 is the blue-color light.

In this way, the intensity of the scattered light can be heightened.

In addition, in the turbidity sensor 1 according to the first embodiment, it is preferable that the light emitted by the light emitting part 121 is the laser light.

In this way, the intensity of the scattered light can be heightened. In addition, the turbidity can be more accurately detected.

In addition, the turbidity sensor 1 according to the first embodiment includes the transmitted light receiving part 123 which receives the light emitted by the light emitting part 121 and totally reflected off the second wall 112.

As described above, by receiving not only the scattered light but also the light totally reflected off the second wall 112, even in a case where the first wall 111 or the second wall 112 of the container 110 is dirty or the liquid 140 is colored, based on the intensity of the totally reflected light, the intensity of the scattered light can be corrected.

In addition, in the turbidity sensor 1 according to the first embodiment, it is preferable that the light emitting part 121 emits the light having the first wavelength and the light having the second wavelength.

In the case where the first wall 111 or the second wall 112 is dirty or the liquid 140 is colored, it is required to correct the actually measured intensity of the scattered light to the intensity of the scattered light resulting when the transmittance is 100%.

As a method for the correction, for example, of the light having the first wavelength and the light having the second wavelength, the light having the relatively short wavelength is used to measure the intensity of the scattered light and the light having the relatively long wavelength is used to measure the intensity of the transmitted light. First, before the liquid 140 is contained in the container 110, the intensity of the transmitted light in the position at the distance L from the light emitting part 121 is previously measured, and the measured intensity is defined as the initial transmitted light intensity. Next, after the liquid 140 has been contained in the container 110, the intensity of the scattered light in the position at the distance L from the light emitting part 121 and the intensity of the transmitted light in the position at the distance L from the light emitting part 121 are measured, and by using {the scattered light intensity/(the transmitted light intensity/the initial transmitted light intensity)}=a post-correction scattered light intensity, the post-correction scattered light intensity can be calculated.

In this way, even in the case where the first wall 111 or the second wall 112 of the container 110 is dirty or the liquid 140 is colored, based on the intensity of the transmitted light, the intensity of the scattered light can be corrected.

### Second Embodiment

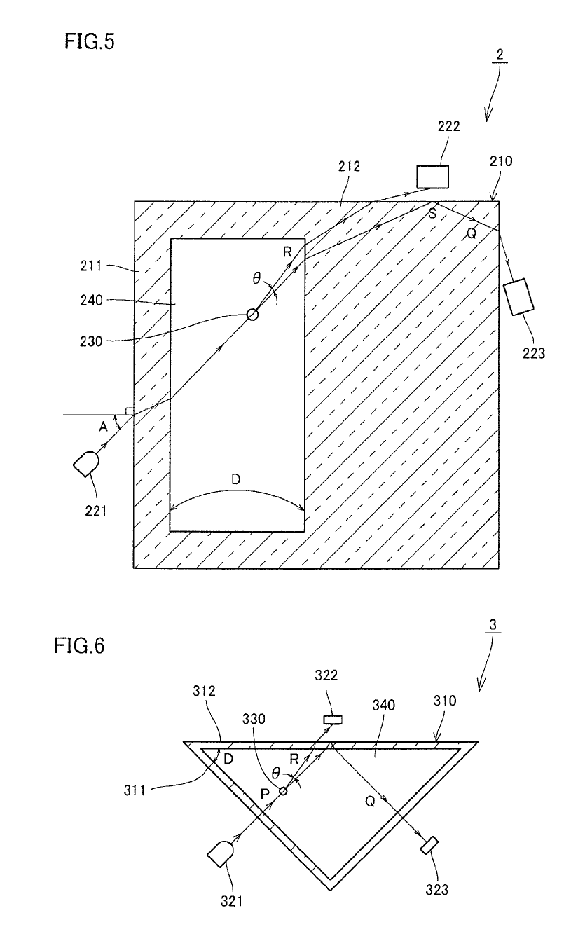

In FIG. 5, a state in which a container 210 of a turbidity sensor 2 as a turbidity detecting device according to a second embodiment of the present invention is viewed from an upper direction is shown. As shown in FIG. 5, the turbidity sensor 2 includes: a container 210; a light emitting part 221; a scattered light receiving part 222 as a light receiving part; and a transmitted light receiving part 223 as a totally reflected light receiving part. The container 210 includes a first wall 211 and a second wall 212. In the container 210, a liquid 240 is contained. In the liquid 240, a turbid substance 230 is included.

In the turbidity sensor 2 according to the second embodiment, thicknesses of walls of the container 210 are not constant. The walls are formed such that the thickness of the first wall 211 is relatively small and the thickness of the second wall 212 is relatively large. In the present embodiment, the container 210 is configured such that an angle D formed between an inner wall surface of the first wall 211 and an inner wall surface of the second wall 212 is 180°. In addition, an angle x formed between an outer wall surface and the inner wall surface of the first wall 211 is 0°, and an angle y formed between an outer wall surface and the inner wall surface of the second wall 212 is 90°.

The light emitting part 221 emits light toward the first wall 211 in a direction indicated by an arrow P. The scattered light receiving part 222 is located outside one surface of the second wall 212. The transmitted light receiving part 223 is located outside a surface of the second wall 212, which faces the first wall 211.

In the present embodiment, for example, the first wall 211 and the second wall 212 of the container 210 are formed of polymethyl methacrylate (PMMA). As the liquid 240 contained in the container 210, water is used. The light emitted by the light emitting part 221 is, for example, sodium D-line light (a wavelength of 589.3 nm). At this time, a refractive index n of the liquid 240 with respect to the light emitted by the light emitting part 221 is 1.33 and a refractive index m of each of the first wall 211 and the second wall 212 with respect to the light emitted by the light emitting part 221 is 1.49. A magnitude of the refractive index m (=1.49) is greater than or equal to a magnitude of the refractive index n (=1.33). The light emitting part 221 is located such that the light emitted by the light emitting part 221 enters the first wall 211 at the incident angle A of, for example, 60°. In addition, the container 210 is formed such that an angle D formed between the inner wall surface of the first wall 211 and the inner wall surface of the second wall 212 comes to be 0°. The container 210 is placed in the air, and a refractive index of the air with respect to the light emitted by the light emitting part 221 is one.

In the turbidity sensor 2 configured as described above, because in (Formula 1), m is equal to 1.49, n is equal to 1.33, D is equal to 0°, A is equal to 60°, x is equal to 0°, and y is equal to 90°, a relationship of the following (Formula 2) holds.

$$1.49 sin ( \begin{matrix}90 ° + \\ arcsin [ \frac{1.33}{1.49} sin \{ \begin{matrix}0 ° - \\ arcsin 〈 \frac{1.49}{1.33} sin ( \begin{matrix}0 ° + \\ arcsin \{ \frac{sin 60 °}{1.49} \}\end{matrix} ) 〉\end{matrix} \} ]\end{matrix} ) = 1.225 > 1 \qquad [ Formula 2 ]$$

When the turbidity sensor 2 is configured as described above, the light applied by the light emitting part 221 to the first wall 211 at the incident angle 60° enters the first wall 211 at a refracting angle 35.5°. The light having entered the first wall 211 passes through the first wall 211 and travels in a straight manner in the liquid 240. The light not scattered by the turbid substance 230 in the liquid 240 enters the second wall 212. The light having entered the second wall 212 enters the air from the second wall 212 at an incident angle 54.5°. Here, because the refractive index m of the second wall 212 with respect to the light emitted by the light emitting part 221 is 1.49, a total reflection angle is 42.16°. Therefore, at a point S, the light traveling in the second wall 212 does not go out from the second wall 212 into the air and is substantially totally reflected off the outer wall surface of the second wall 212.

The light totally reflected off the second wall 212 and traveling in a direction indicated by an arrow Q passes through a wall facing the first wall 211 and is received by the transmitted light receiving part 223.

As described above, the transmitted light receiving part 223 receives the light not scattered by the turbid substance 230 in the liquid 240.

On the other hand, there may be a case where the light emitted by the light emitting part 221 is applied to the turbid substance 230 in the liquid 240. The light applied to the turbid substance 230 by the light emitting part 221 is scattered by the turbid substance 230 at a scatter angle θ. The scattered light scattered at the scatter angle θ travels in a direction indicated by an arrow R. Depending on a magnitude of the scatter angle θ, the scattered light traveling in the direction indicated by the arrow R is not totally reflected off the second wall 212 and passes through the second wall 212. The scattered light having passed through the second wall 212 is received by the scattered light receiving part 222.

As described above, the scattered light receiving part 222 receives the light scattered by the turbid substance 230 in the liquid 240.

As described above, since the light not scattered by the turbid substance 230 is totally reflected off the second wall 212, the light not scattered by the turbid substance 230 is not received by the scattered light receiving part 222. In such a manner, the scattered light receiving part 222 can receive only the light scattered by the turbid substance 230.

The other configuration and effect of the turbidity sensor 2 according to the second embodiment are the same as those of the turbidity sensor 1 according to the first embodiment.

### Third Embodiment

In FIG. 6, a state in which a container 310 of a turbidity sensor 3 as a turbidity detecting device according to a third embodiment of the present invention is viewed from an upper direction is shown. As shown in FIG. 6 the turbidity sensor 3 includes: the container 310; a light emitting part 321; a scattered light receiving part 322 as a light receiving part; and a transmitted light receiving part 323 as a totally reflected light receiving part. The container 310 includes a first wall 311 and a second wall 312. The container 310 is configured so as to have a triangular-shaped cross section including an optical axis of light emitted by the light emitting part 321. In other words, the container 310 is composed of the first wall 311, the second wall 312, and the other wall. In the container 310, a liquid 340 is contained. In the liquid 340, a turbid substance 330 is included.

The light emitting part 321 emits light toward the first wall 311 in a direction indicated by an arrow P. The scattered light receiving part 322 is located outside the second wall 312. The transmitted light receiving part 323 is located outside the other wall.

In the present embodiment, for example, the first wall 311 and the second wall 312 of the container 310 are formed of polymethyl methacrylate (PMMA). As the liquid 340 contained in the container 310, water is used. The light emitted by the light emitting part 321 is, for example, sodium D-line light (a wavelength of 589.3 nm). At this time, a refractive index n of the liquid 340 with respect to the light emitted by the light emitting part 321 is 1.33 and a refractive index m of each of the first wall 311 and the second wall 312 with respect to the light emitted by the light emitting part 321 is 1.49. A magnitude of the refractive index m (=1.49) is greater than or equal to a magnitude of the refractive index n (=1.33). The light emitting part 321 is located such that the light emitted by the light emitting part 321 enters the first wall 311 at an incident angle A of, for example, 0°. In addition, the container 310 is formed such that an angle D formed between an inner wall surface of the first wall 311 and an inner wall surface of the second wall 312 comes to be, for example, 60°. The container 310 is placed in the air, and a refractive index of the air with respect to the light emitted by the light emitting part 321 is one. In addition, an angle x formed between an outer wall surface and the inner wall surface of the first wall 311 is 0°, and an angle y formed between an outer wall surface and the inner wall surface of the second wall 312 is 0°.

In the turbidity sensor 3 configured as described above, because in (Formula 1), x is equal to 0° and y is equal to 0°, a relationship of (Formula 1)=n sin [D−arcsin {(sin A)/n}]=1.33 sin [60°−arcsin {(sin 0°)/1.33}]=1.15>1 holds.

When the turbidity sensor 3 is configured as described above, the light applied by the light emitting part 321 to the first wall 311 at the incident angle 0° enters the first wall 311 at a refracting angle 0°. The light having entered the first wall 311 passes through the first wall 311 and travels in a straight manner in the liquid 340. The light not scattered by the turbid substance 330 in the liquid 340 enters the second wall 312. The light having entered the second wall 312 does not go out from the second wall 312 into the air and is substantially totally reflected off the outer wall surface of the second wall 312.

The light totally reflected off the second wall 312 and traveling in a direction indicated by an arrow Q is received by the transmitted light receiving part 323 located outside the container 310.

As described above, the transmitted light receiving part 323 receives the light not scattered by the turbid substance 330 in the liquid 340.

On the other hand, there may be a case where the light emitted by the light emitting part 321 is applied to the turbid substance 330 in the liquid 340. The light applied to the turbid substance 330 by the light emitting part 321 is scattered by the turbid substance 330 at a scatter angle θ. The scattered light scattered at the scatter angle θ travels in a direction indicated by an arrow R. Depending on a magnitude of the scatter angle θ, the scattered light traveling in the direction indicated by the arrow R is not totally reflected off the second wall 312 and passes through the second wall 312. The scattered light having passed through the second wall 312 is received by the scattered light receiving part 322.

As described above, the scattered light receiving part 322 receives the light scattered by the turbid substance 330 in the liquid 340.

As described above, since the light not scattered by the turbid substance 330 is totally reflected off the second wall 312, the light not scattered by the turbid substance 330 is not received by the scattered light receiving part 322. In such a manner, the scattered light receiving part 322 can receive only the light scattered by the turbid substance 330.

The other configuration and effect of the turbidity sensor 3 according to the third embodiment are the same as those of the turbidity sensor 1 according to the first embodiment.

### Fourth Embodiment

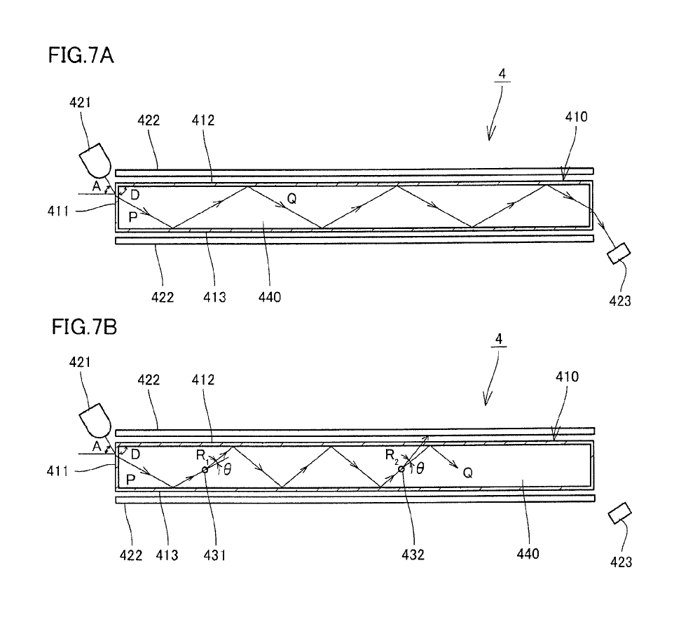

In FIG. 7A and FIG. 7B, a state in which a container 410 of a turbidity sensor 4 as a turbidity detecting device according to a fourth embodiment of the present invention is viewed from an upper direction is shown. As shown in FIG. 7A and FIG. 7B, the turbidity sensor 4 includes: a container 410; a light emitting part 421; a scattered light receiving part 422 as a light receiving part; and a transmitted light receiving part 423 as a totally reflected light receiving part. The container 410 includes a first wall 411, a second wall 412, and a third wall 413. An angle formed between the first wall 411 and the second wall 412 is an angle D. The first wall 411 is located between the second wall 412 and the third wall 413. The second wall 412 and the third wall 413 are located in parallel with each other, with the first wall 411 interposed therebetween. The container 410 is configured such that a cross section thereof including an optical axis of light emitted by the light emitting part 421 is of a rectangular shape. In the container 410, a liquid 440 is contained. In the liquid 440, turbid substances 431 and 432 are included.

The light emitting part 421 emits light toward the first wall 411 in a direction indicated by an arrow P, that is, a direction toward the third wall 413. The scattered light receiving part 422 is located outside the second wall 412 and outside the third wall 413. The scattered light receiving part 422 is located outside the container 410 so as to cover the whole of an outer wall surface of each of the second wall 412 and the third wall 413. The transmitted light receiving part 423 is located outside a wall facing the first wall 411.

In the present embodiment, for example, the first wall 411, the second wall 412, and the third wall 413 of the container 410 are formed of polymethyl methacrylate (PMMA). As the liquid 440 contained in the container 410, water is used. The light emitted by the light emitting part 421 is, for example, sodium D-line light (a wavelength of 589.3 nm). At this time, a refractive index n of the liquid 440 with respect to the light emitted by the light emitting part 421 is 1.33 and a refractive index m of each of the first wall 411 and the second wall 412 with respect to the light emitted by the light emitting part 421 is 1.49. A magnitude of the refractive index m 1.49) is greater than or equal to a magnitude of the refractive index n (=1.33). The light emitting part 421 is located such that the light emitted by the light emitting part 421 enters the first wall 411 at an incident angle A of, for example, 60°. In addition, the container 410 is formed such that an angle D formed between an inner wall surface of the first wall 411 and an inner wall surface of the second wall 412 comes to be, for example, 90°. The container 410 is placed in the air, and a refractive index of the air with respect to the light emitted by the light emitting part 421 is one. In addition, an angle x formed between an outer wall surface and the inner wall surface of the first wall 411 is set to 0°, and an angle y formed between an outer wall surface and the inner wall surface of the second wall 412 is set to 0°.

In the turbidity sensor 4 configured as described above, because in (Formula 1), x is equal to 0° and y is equal to 0°, a relationship of (Formula 1)=n sin [D−arcsin {(sin A)/n}]=1.33 sin [60°−arcsin {(sin 90°)/1.33}]=1.01>1 holds.

In a case where in the turbidity sensor 4, the above-mentioned relationship holds, when the light applied by the light emitting part 421 to the first wall 411 at the incident angle A is not scattered by the turbid substances in the liquid 440, even if the light enters the second wall 412, with which the first wall 411 forms the angle D, the light does not pass through the second wall 412 and is totally reflected off the second wall 412.

As shown in FIG. 7A, when the turbidity sensor 4 is configured as described above, the light applied by the light emitting part 421 to the first wall 411 at the incident angle 60° enters the first wall 411 at a refracting angle 35.5°. The light having entered the first wall 411 passes through the first wall 411 and travels in a straight manner in the liquid 440, heading toward the third wall 413. The light not scattered by the turbid substances in the liquid 440 is substantially totally reflected off the third wall 413 and thereafter, enters the second wall 412. The light having entered the second wall 412 does not go out from the second wall 412 into the air and is substantially totally reflected off the outer wall surface of the second wall 412.

The light totally reflected off the second wall 412 and traveling in a direction indicated by an arrow Q is received by the transmitted light receiving part 423 located outside the container 410.

On the other hand, as shown in FIG. 7B, there may be a case where the light emitted by the light emitting part 421 is applied to the turbid substance 431 in the liquid 440. The light applied to the turbid substance 431 by the light emitting part 421 is scattered by the turbid substance 431 at a scatter angle θ. The scattered light scattered at the scatter angle θ travels in a direction indicated by an arrow R₁. Depending on a magnitude of the scatter angle θ, the scattered light traveling in the direction indicated by the arrow R₁ is totally reflected off the second wall 412.

The scattered light totally reflected off the second wall 412 travels in the liquid 440 and again, is reflected off the third wall 413 located in parallel with the second wall 412. The scattered light reflected off the third wall 413 travels in a straight manner in the liquid 440, heading toward the second wall 412 located in parallel with third wall 413. At this time, there may be a case where the scattered light is scattered by the turbid substance 432 at a scatter angle θ. The scattered light scattered at the scatter angle θ travels in a direction indicated by an arrow R₂. Depending on a magnitude of the scatter angle θ, the scattered light traveling in the direction indicated by the arrow R₂ is not totally reflected off the second wall 412 and passes through the second wall 412. The scattered light having passed through the second wall 412 is received by the scattered light receiving part 422.

In this way, the scattered light receiving part 422 receives the light scattered by the turbid substances 431 and 432 in the liquid 440.

As described above, since the light not scattered by at least the turbid substances 431 and 432 is totally reflected off the second wall 412, the light not scattered thereby is not received by the scattered light receiving part 422. In such a manner, the scattered light receiving part 422 can receive only the light scattered by the turbid substances 431 and 432.

In the present embodiment, when because x is equal to 0° and y is equal to 0°, with the angle formed between the first wall 411 and the third wall 413 being the angle D, a relationship of (Formula 1)=n sin [D−arcsin {(sin A)/n}]>1 holds, the third wall 413 can also be used as one example of the second wall 412. In other words, when the light emitted by the light emitting part 421 is not scattered by the turbid substances 431 and 432, the light is substantially totally reflected off the third wall 413 and is not received by the scattered light receiving part 422 outside the third wall 413.

As described above, in the turbidity sensor 4 according to the fourth embodiment, the container 410 includes the third wall 413. The third wall 413 is located so as to cause the light passing through the first wall 411 to be reflected off an inner wall surface of the third wall 413 and thereafter, to be applied to the second wall 412.

In this way, a probability at which the light emitted by the light emitting part 421 is applied to the turbid substances 431 and 432 is enhanced, thereby allowing an intensity of the scattered light to be heightened.

The other configuration and effect of the turbidity sensor 4 according to the fourth embodiment are the same as those of the turbidity sensor 1 according to the first embodiment.

### Fifth Embodiment

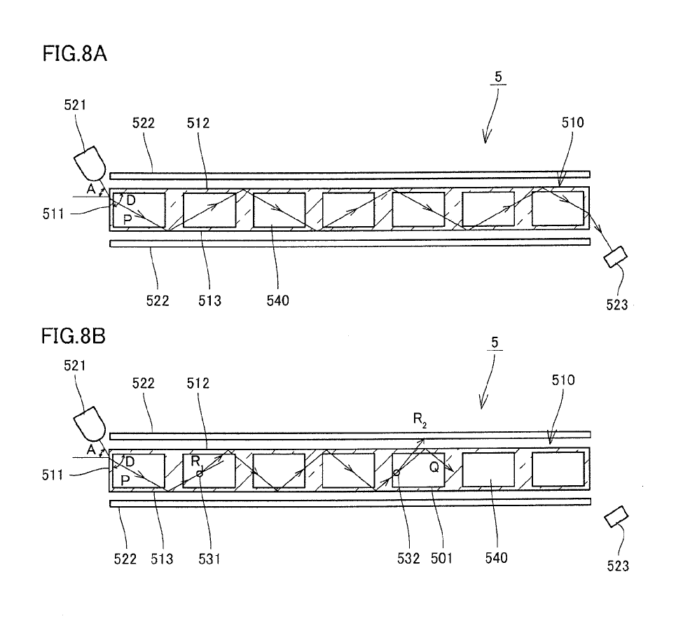

In FIG. 8A and FIG. 8B, a state in which a container 510 of a turbidity sensor 5 as a turbidity detecting device according to a fifth embodiment of the present invention is viewed from an upper direction are shown. As shown in FIG. 8A and FIG. 8B, the turbidity sensor 5 includes: a container 510; a light emitting part 521; a scattered light receiving part 522 as a light receiving part; and a transmitted light receiving part 523 as a totally reflected light receiving part. The container 510 includes a first wall 511, a second wall 512, and a third wall 513. Inside the container 510, a plurality of liquid storage parts 501 are formed. An angle formed between the first wall 511 and the second wall 512 is an angle D. The first wall 511 is located between the second wall 512 and the third wall 513. The second wall 512 and the third wall 513 are located in parallel with each other, with the first wall 511 interposed therebetween. The container 510 is configured such that a cross section thereof including an optical axis of light emitted by the light emitting part 521 is of a rectangular shape. In each of the liquid storage parts 501 inside the container 510, a liquid 540 is contained. In the liquid 540, turbid substances 531 and 532 are included.

The light emitting part 521 emits light toward the first wall 511 in a direction indicated by an arrow P, that is, a direction toward the third wall 513. The scattered light receiving part 522 is located outside the second wall 512 and outside the third wall 513. The scattered light receiving part 522 is located outside the container 510 so as to cover the whole of an outer wall surface of each of the second wall 512 and the third wall 513. The transmitted light receiving part 523 is located outside a wall facing the first wall 511.

In the present embodiment, for example, the first wall 511, the second wall 512, and the third wall 513 of the container 510 are formed of polymethyl methacrylate (PMMA). As the liquid 540 contained in the container 510, water is used. The light emitted by the light emitting part 521 is, for example, sodium D-line light (a wavelength of 589.3 nm). At this time, a refractive index n of the liquid 540 with respect to the light emitted by the light emitting part 521 is 1.33 and a refractive index m of each of the first wall 511 and the second wall 512 with respect to the light emitted by the light emitting part 521 is 1.49. A magnitude of the refractive index m (=1.49) is greater than or equal to a magnitude of the refractive index n (=1.33). The light emitting part 521 is located such that the light emitted by the light emitting part 521 enters the first wall 511 at an incident angle A of, for example, 60°. In addition, the container 510 is formed such that the angle D formed between an inner wall surface of the first wall 511 and an inner wall surface of the second wall 512 comes to be, for example, 90°. The container 510 is placed in the air, and a refractive index of the air with respect to the light emitted by the light emitting part 521 is one. In addition, an angle x formed between an outer wall surface and the inner wall surface of the first wall 511 is set to 0°, and an angle y formed between an outer wall surface and the inner wall surface of the second wall 512 is set to 0°.

In the turbidity sensor 5 configured as described above, because in (Formula 1), x is equal to 0° and y is equal to 0°, a relationship of (Formula 1)=n sin [D−arcsin {(sin A)/n}]=1.33 sin [60°−arcsin {(sin 90°)/1.33}]=1.01>1 holds.

In a case where in the turbidity sensor 5, the above-mentioned relationship holds, when the light applied by the light emitting part 521 to the first wall 511 at the incident angle A is not scattered by the turbid substances in the liquid 540, even if the light enters the second wall 512, with which the first wall 511 forms the angle D, the light does not pass through the second wall 512 and is totally reflected off the second wall 512.

As shown in FIG. 8A, when the turbidity sensor 5 is configured as described above, the light applied by the light emitting part 521 to the first wall 511 at the incident angle 60° enters the first wall 511 at a refracting angle 35.5°. The light having entered the first wall 511 passes through the first wall 511 and travels in a straight manner in the liquid 540, heading toward the third wall 513. The light not scattered by the turbid substances in the liquid 540 is substantially totally reflected off the third wall 513 and thereafter, enters the second wall 512. The light having entered the second wall 512 does not go out from the second wall 512 into the air and is substantially totally reflected off the outer wall surface of the second wall 512.

The light totally reflected off the second wall 512 and traveling in a direction indicated by an arrow Q is received by the transmitted light receiving part 523 located outside the container 510.

On the other hand, as shown in FIG. 8B, there may be a case where the light emitted by the light emitting part 521 is applied to the turbid substance 531 in the liquid 540. The light applied to the turbid substance 531 by the light emitting part 521 is scattered by the turbid substance 531 at a scatter angle θ. The scattered light scattered at the scatter angle θ travels in a direction indicated by an arrow R₁. Depending on a magnitude of the scatter angle θ, the scattered light traveling in the direction indicated by the arrow R₁ is totally reflected off the second wall 512.

The scattered light totally reflected off the second wall 512 travels in the liquid 540 and again, is reflected off the third wall 513 located in parallel with the second wall 512. The scattered light reflected off the third wall 513 travels in a straight manner in the liquid 540, heading toward the second wall 512 located in parallel with third wall 513. At this time, there may be a case where the scattered light is scattered by the turbid substance 532 at a scatter angle θ. The scattered light scattered at the scatter angle θ travels in a direction indicated by an arrow R₂. Depending on a magnitude of the scatter angle θ, the scattered light traveling in the direction indicated by the arrow R₂ is not totally reflected off the second wall 512 and passes through the second wall 512. The scattered light having passed through the second wall 512 is received by the scattered light receiving part 522.

In this way, the scattered light receiving part 522 receives the light scattered by the turbid substances 531 and 532 in the liquid 540.

As described above, since the light not scattered by at least the turbid substances 531 and 532 is totally reflected off the second wall 512, the light not scattered thereby is not received by the scattered light receiving part 522. In such a manner, the scattered light receiving part 522 can receive only the light scattered by the turbid substances 531 and 532.

In the present embodiment, when with the angle formed between the first wall 511 and the third wall 513 being the angle D, a relationship of (Formula 1)=n sin [D−arcsin {(sin A)/n}]>1 holds, the third wall 513 can also be used as one example of the second wall 512. In other words, when the light emitted by the light emitting part 521 is not scattered by the turbid substances 531 and 532, the light is substantially totally reflected off the third wall 513 and is not received by the scattered light receiving part 522 outside the third wall 513.

The other configuration and effect of the turbidity sensor 5 according to the fifth embodiment are the same as those of the turbidity sensor 4 according to the fourth embodiment.

### Sixth Embodiment

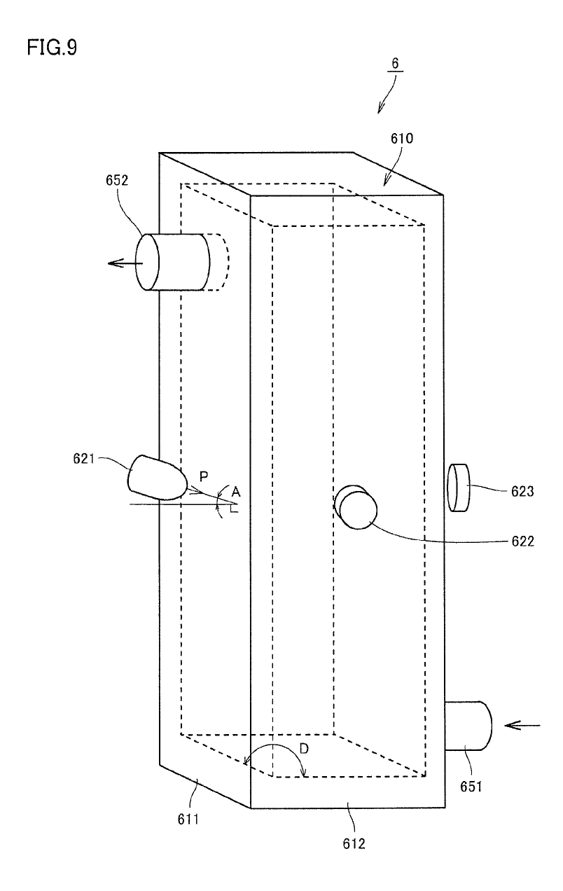

As shown in FIG. 9, a turbidity sensor 6 as a turbidity detecting device according to a sixth embodiment of the present invention includes: a container 610, a light emitting part 621, a scattered light receiving part 622 as a light receiving part, and a transmitted light receiving part 623 as a totally reflected light receiving part. The container 610 includes a first wall 611 and a second wall 612. An angle formed between the first wall 611 and the second wall 612 is an angle D. The container 610 is formed so as to be of a substantially rectangular parallelepiped shape and so as to have a dimension in a horizontal direction, which is smaller than a height. In a lower portion of the container 610, an inlet port 651 for causing a liquid to flow into an inside of the container 610 from an outside of the container 610 is formed. In an upper portion of the container 610, an outlet port 652 for causing the liquid to flow out from the inside of the container 610 to the outside of the container 610 is formed. The liquid flowing into the container 610 from the inlet port 651 is contained in the container 610 between the inlet port 651 and the outlet port 652. In the liquid, a turbid substance is included.

The light emitting part 621 emits light toward the first wall 611 in a direction indicated by an arrow P, that is, a direction toward the second wall 612. The scattered light receiving part 622 is located outside the second wall 612. The transmitted light receiving part 623 is located outside a wall facing the first wall 611.

In the present embodiment, for example, the first wall 11 and the second wall 612 of the container 610 are formed of polymethyl methacrylate (PMMA). As the liquid contained in the container 610, water is used. The light emitted by the light emitting part 621 is, for example, sodium D-line light (a wavelength of 589.3 nm). At this time, a refractive index n of the liquid with respect to the light emitted by the light emitting part 621 is 1.33 and a refractive index m of each of the first wall 611 and the second wall 612 with respect to the light emitted by the light emitting part 621 is 1.49. A magnitude of the refractive index m (=1.49) is greater than or equal to a magnitude of the refractive index n (=1.33). The light emitting part 621 is located such that the light emitted by the light emitting part 621 enters the first wall 611 at an incident angle A of, for example, 60°. In addition, the container 610 is formed such that the angle D formed between an inner wall surface of the first wall 611 and an inner wall surface of the second wall 612 comes to be, for example, 90°. The container 610 is placed in the air, and a refractive index of the air with respect to the light emitted by the light emitting part 621 is one. In addition, an angle x formed between an outer wall surface and the inner wall surface of the first wall 611 is set to 0°, and an angle y formed between an outer wall surface and the inner wall surface of the second wall 612 is set to 0°.

In the turbidity sensor 6 configured as described above, because in (Formula 1), x is equal to 0° and y is equal to 0°, a relationship of (Formula 1)=n sin [D−arcsin {(sin A)/n}]=1.33 sin [60°−arcsin {(sin 90°)/1.33}]=1.01>1 holds.

In a case where the turbidity sensor 6, the above-mentioned relationship holds, when the light applied by the light emitting part 621 to the first wall 611 at the incident angle A is not scattered by the turbid substance in the liquid 640, even if the light enters the second wall 612, with which the first wall 611 forms the angle D, the light does not pass through the second wall 612 and is totally reflected off the second wall 612. On the other hand, depending on a magnitude of the scatter angle, the scattered light scattered by the turbid substance in the liquid is not totally reflected off the second wall 612 and passes through the second wall 612. The scattered light having passed through the second wall 612 is received by the scattered light receiving part 622.

As described above, in the turbidity sensor 6 according to the sixth embodiment, in the container 610, the inlet port 651 for causing the liquid to flow into the container 610 and the outlet port 652 for causing the liquid to flow out from the container 610 are formed.

By employing this configuration, while the liquid is being flowing into the container 610, a turbidity of the liquid can be detected.

The other configuration and effect of the turbidity sensor 6 according to the sixth embodiment are the same as those of the turbidity sensor 1 according to the first embodiment.

### Seventh Embodiment

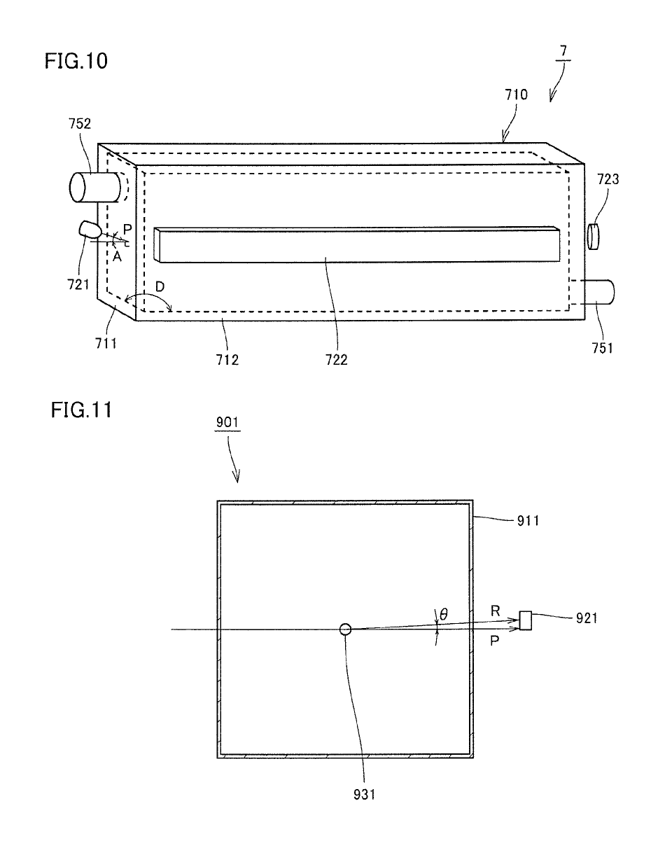

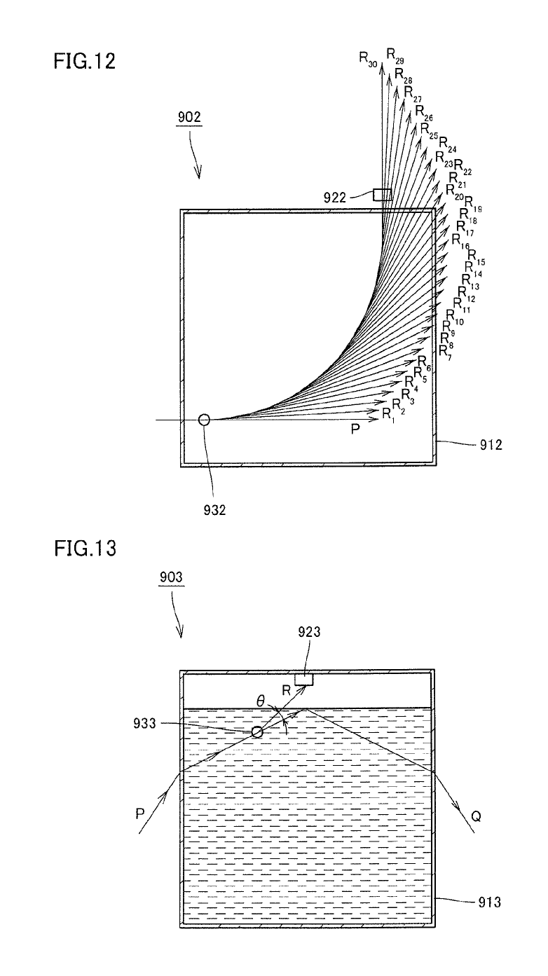

As shown in FIG. 10, a turbidity sensor 7 as a turbidity detecting device according to a seventh embodiment of the present invention includes: a container 710, a light emitting part 721, a scattered light receiving part 722 as a light receiving part, and a transmitted light receiving part 723 as a totally reflected light receiving part. The container 710 includes a first wall 711 and a second wall 712. An angle formed between the first wall 711 and the second wall 712 is an angle D. The container 710 is formed so as to be of a substantially rectangular parallelepiped shape and so as to have a dimension in a horizontal direction, which is larger than a height in a vertical direction. In a lower portion of the container 710, an inlet port 751 for causing a liquid to flow into an inside of the container 710 from an outside of the container 710 is formed. In an upper portion of the container 710, an outlet port 752 for causing the liquid to flow out from the inside of the container 710 to the outside of the container 710 is formed. The liquid flowing into the container 710 from the inlet port 751 is contained in the container 710 between the inlet port 751 and the outlet port 752. In the liquid, a turbid substance is included.

The light emitting part 721 emits light toward the first wall 711 in a direction indicated by an arrow P, that is, a direction toward the second wall 712. The scattered light receiving part 722 is located outside the second wall 712. The transmitted light receiving part 723 is located outside a wall facing the first wall 711.

In the present embodiment, for example, the first wall 711 and the second wall 712 of the container 710 are formed of polymethyl methacrylate (PMMA). As the liquid contained in the container 710, water is used. The light emitted by the light emitting part 721 is, for example, sodium D-line light (a wavelength of 589.3 nm). At this time, a refractive index n of the liquid with respect to the light emitted by the light emitting part 721 is 1.33 and a refractive index m of each of the first wall 711 and the second wall 712 with respect to the light emitted by the light emitting part 721 is 1.49. A magnitude of the refractive index m (=1.49) is greater than or equal to a magnitude of the refractive index n (=1.33). The light emitting part 721 is located such that the light emitted by the light emitting part 721 enters the first wall 711 at an incident angle A of, for example, 60°. In addition, the container 710 is formed such that the angle D formed between an inner wall surface of the first wall 711 and an inner wall surface of the second wall 712 comes to be, for example, 90°. The container 710 is placed in the air, and a refractive index of the air with respect to the light emitted by the light emitting part 721 is one. In addition, an angle x formed between an outer wall surface and the inner wall surface of the first wall 711 is set to 0°, and an angle y formed between an outer wall surface and the inner wall surface of the second wall 712 is set to 0°.

In the turbidity sensor 7 configured as described above, because in (Formula 1), x is equal to 0° and y is equal to 0°, a relationship of (Formula 1)=n sin [D−arcsin {(sin A)/n}]=1.33 sin [60°−arcsin {(sin 90°)/1.33}]=1.01>1 holds.

In the turbidity sensor 7, in a case where the above-mentioned relationship holds, when the light applied by the light emitting part 721 to the first wall 711 at the incident angle A is not scattered by the turbid substances in the liquid, even if the light enters the second wall 712, with which the first wall 711 forms the angle D, the light does not pass through the second wall 712 and is totally reflected off the second wall 712. On the other hand, depending on a magnitude of the scatter angle, the scattered light scattered by the turbid substance in the liquid is not totally reflected off the second wall 712 and passes through the second wall 712. The scattered light having passed through the second wall 712 is received by the scattered light receiving part 722.

As described above, in the turbidity sensor 7 according to the seventh embodiment, in the container 710, the inlet port 751 for causing the liquid to flow into the container 710 and the outlet port 752 for causing the liquid to flow out from the container 710 are formed.

By employing this configuration, while the liquid is being flowing into the container 710, a turbidity of the liquid can be detected.

An inside of the turbidity sensor 7 may be configured so as to be like an inside of the turbidity sensor 4 according to the fourth embodiment shown in FIG. 7A and FIG. 7B or an inside of the turbidity sensor 5 according to the fifth embodiment shown in FIG. 8A and FIG. 8B.

The other configuration and effect of the turbidity sensor 7 according to the seventh embodiment are the same as those of the turbidity sensor 1 according to the first embodiment.

The described embodiments are to be considered in all respects only as illustrative and not restrictive. It is intended that the scope of the invention is, therefore, indicated by the appended claims rather than the foregoing descriptions of the embodiments and that all modifications and variations coming within the meaning and equivalency range of the appended claims are embraced within their scope.

### INDUSTRIAL APPLICABILITY

Since the present invention can provide a turbidity detecting device capable of detecting a turbidity of a turbidity-detection-targeted liquid having a small turbidity and a minute change in a turbidity, the present invention is useful in relation to a turbidity detecting device.

### REFERENCE SIGNS LIST

1, 2, 3, 4, 5, 6, 7: turbidity sensor; 110, 210, 310, 410, 510, 610, 710: container; 111, 211, 311, 411, 511, 611, 711: first wall; 111, 212, 312, 412, 512, 612, 712: second wall; 413, 513: third wall; 121, 221, 321, 421, 521, 621, 721: light emitting part; 122, 222, 322, 422, 522, 622, 722: scattered light receiving part; 123, 223, 323, 423, 523, 623, 723: transmitted light receiving part; 651, 751: inlet port; and 652, 752: outlet port.

1. A turbidity detecting device comprising:
a container including a first wall and a second wall and containing a liquid;
a light emitting part emitting light from an outside of the container, causing the light to pass through the first wall, and applying the light to the second wall; and
a light receiving part receiving the light emitted by the light emitting part and passing through the second wall
among an incident angle A, the light emitted by the light emitting part entering the first wall of the container from an outside of the container at the incident angle A; an angle D (0°≦D≦180°) formed between an inner wall surface of the first wall and an inner wall surface of the second wall; a refractive index n of the liquid contained in the container with respect to the light emitted by the light emitting part; a refractive index m of a material with respect to the light emitted by the light emitting part, the first wall and the second wall being formed of the material; an angle x formed between an outer wall surface of and the inner wall surface of the first wall; and an angle y (−90°≦y≦90°) formed between an outer wall surface and the inner wall surface of the second wall, a relationship of the following holding.
$$m sin ( \begin{matrix}y + \\ arcsin [ \frac{n}{m} sin \{ D - arcsin 〈 \frac{m}{n} sin ( \begin{matrix}x + \\ arcsin \{ \frac{sin A}{m} \}\end{matrix} ) 〉 \} ]\end{matrix} ) > 1 \qquad [ Formula 1 ]$$

2. The turbidity detecting device according to claim 1, wherein
the first wall and the second wall are formed of a material whose refractive index m with respect to the light emitted by the light emitting part is greater than or equal to √2,
the angle D formed between the inner wall surface of the first wall and the inner wall surface of the second wall is 90°,
the angle x formed between the outer wall surface and the inner wall surface of the first wall is 0°, and the angle y formed between the outer wall surface and the inner wall surface of the second wall is 0°, and
a magnitude of the refractive index m is greater than or equal to a magnitude of the refractive index n of the liquid contained in the container with respect to the light emitted by the light emitting part.

3. The turbidity detecting device according to claim 1, wherein
the container includes a third wall, and
the third wall is located such that the light passing through the first wall is reflected off an inner wall surface of the third wall and thereafter, is applied to the second wall.

4. The turbidity detecting device according to claim 1, wherein in the container, an inlet port causing the liquid to flow into the container and an outlet port causing the liquid flow out from the container are formed.

5. The turbidity detecting device according to claim 1, wherein the light emitted by the light emitting part is blue-color light.

6. The turbidity detecting device according to claim 1, wherein the light emitted by the light emitting part is laser light.

7. The turbidity detecting device according to claim 1, comprising a totally reflected light receiving part receiving the light emitted by the light emitting part and totally reflected off the second wall.

8. The turbidity detecting device according to claim 7, wherein the light emitting part emits light having a first wavelength and light having a second wavelength.
